(19) United States
(12) Patent Application Publication
(10) Pub. No.: US 2022/0019753 A1
(43) Pub. Date: Jan. 20, 2022

(54) FINGERPRINT SENSING APPARATUS

(71) Applicant: Egis Technology Inc., Taipei (TW)

(72) Inventors: Di Bao Wang, Taipei (TW); Chen-Chih Fan, Taipei (TW)

(73) Assignee: Egis Technology Inc., Taipei (TW)

(21) Appl. No.: 17/343,755

(22) Filed: Jun. 10, 2021

Related U.S. Application Data
(60) Provisional application No. 63/054,223, filed on Jul. 20, 2020.
(60) Provisional application No. 63/054,249, filed on Jul. 21, 2020.

(30) Foreign Application Priority Data
Apr. 12, 2021 (CN) 202110390381.9

(51) Int. Cl. G06K 9/00

(52) U.S. Cl. CPC G06K 9/0002

(57) ABSTRACT

A fingerprint sensing apparatus is provided. A driving circuit drives a capacitive micromachined ultrasonic transducer (CMUT) array to emit a planar ultrasonic wave to a finger during a transmission period to generate reflected ultrasonic signals. CMUTs receive the reflected ultrasonic signals during a receiving period to generate sensing current signals. A sensing circuit senses the sensing current signals output by the CMUTs to generate fingerprint sensing signals.

### CROSS-REFERENCE TO RELATED APPLICATION

This application claims the priority benefits of U.S. provisional application Ser. No. 63/054,223, filed on Jul. 20, 2020, U.S. provisional application Ser. No. 63/054,249, filed on Jul. 21, 2020, and Chinese application no. 202110390381.9, filed on Apr. 12, 2020. The entirety of each of the above-mentioned patent applications is hereby incorporated by reference herein and made a part of this specification.

### BACKGROUND

### Technical Field

The disclosure relates to a sensing apparatus; in particular, the disclosure relates to a fingerprint sensing apparatus.

### Description of Related Art

Currently, fingerprint recognition is widely applied in various electronic products, and most commonly in portable mobile devices such as smart phones and tablet computers. Currently in the fingerprint recognition applied to smart phones, forms of common fingerprint sensing apparatuses may be categorized into an optical form, a capacitive form, ultrasonic form, etc. By utilizing a piezoelectric micromachined ultrasonic transducer (PMUT), common ultrasonic fingerprint sensing apparatuses transmit and receive ultrasonic waves for fingerprint sensing. Since the PMUT requires a higher AC drive voltage (100 to 200V) and needs to be manufactured on a silicon substrate to be manufactured with a complementary metal-oxide semiconductor (CMOS) circuit, the manufacturing costs are relatively high, adversely affecting application to a large-area fingerprint sensing.

### SUMMARY

The disclosure provides a fingerprint sensing apparatus, in which manufacturing costs of an ultrasonic fingerprint sensing apparatus is reduced, facilitating application to large-area fingerprint sensing.

According to an embodiment of the disclosure, a fingerprint sensing apparatus includes a signal emission receiving layer, a driving circuit, a sensing circuit layer, and a substrate. The signal emission receiving layer includes a capacitive micromachined ultrasonic transducer array formed by a plurality of capacitive micromachined ultrasonic transducers. The driving circuit is coupled to the capacitive micromachined ultrasonic transducer array, and drives the capacitive micromachined ultrasonic transducer array to emit a planar ultrasonic wave to a finger during a transmission period to generate a plurality of reflected ultrasonic signals. The capacitive micromachined ultrasonic transducers receive the reflected ultrasonic signals during a receiving period to generate a plurality of sensing current signals. The sensing circuit layer includes a plurality of sensing circuits. The sensing circuits are respectively coupled to the corresponding capacitive micromachined ultrasonic transducers, and sense the sensing current signals output by the capacitive micromachined ultrasonic transducers to generate a plurality of fingerprint sensing signals. The sensing circuit layer is formed on the substrate, and the signal emission receiving layer is formed on the sensing circuit layer. The substrate is a glass substrate or a silicon substrate.

Based on the foregoing, in the embodiments of the disclosure, the driving circuit may drive the micro-machined ultrasonic transducer array to emit the planar ultrasonic wave to the finger during the transmission period to generate the reflected ultrasonic signals. The micromachined ultrasonic transducer may receive the reflected ultrasonic signals during the receiving period to generate the sensing current signals. The sensing circuit senses the sensing current signals output by the micromechanical ultrasonic transducers to generate the fingerprint sensing signals. Compared with fingerprint sensing utilizing piezoelectric micromachined ultrasonic transducers, fingerprint sensing utilizing the micromachined ultrasonic transducers requires a lower AC drive voltage. In addition, since the micromachined ultrasonic transducers may be formed on a glass substrate, compared to the manufacturing using a silicon substrate, the manufacturing costs are reduced, facilitating application to large-area fingerprint sensing.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a fingerprint sensing apparatus according to an embodiment of the disclosure.

FIG. 2 is a schematic diagram of a fingerprint sensing apparatus according to another embodiment of the disclosure.

FIG. 3 is a schematic diagram of a driving signal according to an embodiment of the disclosure.

FIG. 4 is a schematic diagram of a driving circuit according to an embodiment of the disclosure.

FIG. 5 is a schematic diagram of a driving signal according to another embodiment of the disclosure.

FIG. 6 is a schematic diagram of a sensing circuit according to an embodiment of the disclosure.

FIG. 7 is a waveform diagram of a sensing current signal, a reading control signal, and a fingerprint sensing signal according to an embodiment of the disclosure.

FIG. 8 is a schematic diagram of a sensing circuit according to another embodiment of the disclosure.

### DESCRIPTION OF THE EMBODIMENTS

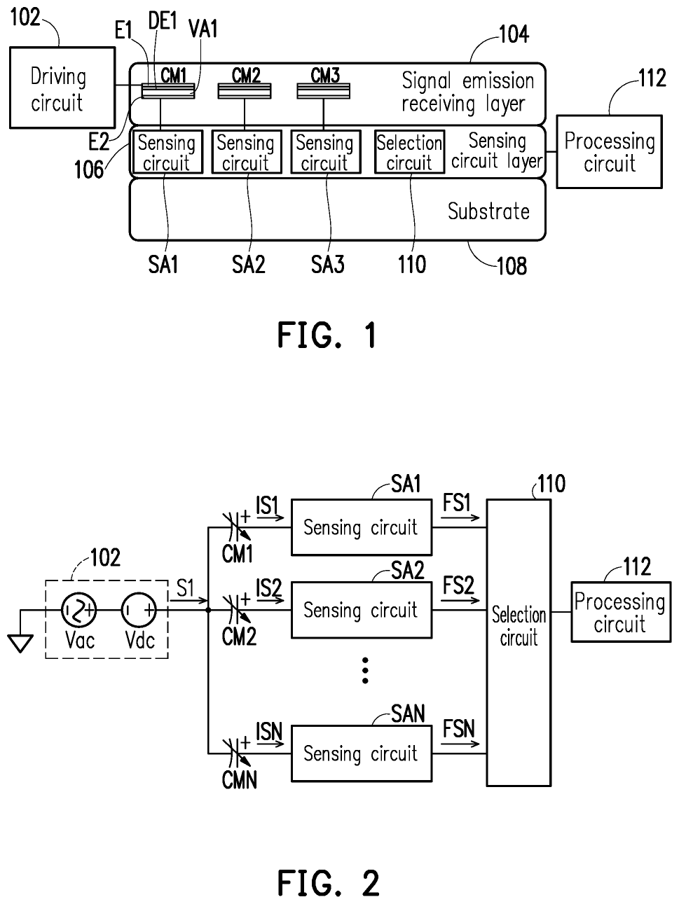

FIG. 1 is a schematic diagram of a fingerprint sensing apparatus according to an embodiment of the disclosure. With reference to FIG. 1, the fingerprint sensing apparatus may include a driving circuit 102, a signal emission receiving layer 104, a sensing circuit layer 106, a substrate 108, and a processing circuit 112. The sensing circuit layer 106 is formed on the substrate 108, and the signal emission receiving layer 104 is formed on the sensing circuit layer 106. The substrate 108 is, for example, a glass substrate or a silicon substrate. The signal emission receiving layer 104 is coupled to the driving circuit 102, and the sensing circuit layer 106 is coupled to the processing circuit 112. The signal emission receiving layer 104 includes a capacitive micromachined ultrasonic transducer array formed by a plurality of capacitive micromachined ultrasonic transducers (CMUT) CM1 to CMN, and the driving circuit 102 is coupled to the capacitive micromachined ultrasonic transducer array. In addition, the sensing circuit layer 106 may be manufactured, for example, through a thin film transistor (TFT) process to be formed on a glass substrate or through a complementary metal-oxide semiconductor (CMOS) process to be formed on a silicon substrate. The sensing circuit layer 106 includes a plurality of sensing circuits SA1 to SAN and a selection circuit 110. Herein, N is a positive integer. For ease of description, only three capacitive micromachined ultrasonic transducers CM1 to CM3 and three sensing circuits SA1 to SA3 are shown in FIG. 1, but the actual application is not limited thereto.

To be more specific, taking the capacitive micromachined ultrasonic transducer CM1 as an example, each capacitive micromachined ultrasonic transducer may include electrode layers E1 and E2 and a dielectric layer DE1. The dielectric layer DE1 is disposed between the electrode layers E1 and E2, and a cavity VA1 is formed between the dielectric layer DE1 and the electrode layer E2. The materials of the electrode layers E1 and E2 may, for example, include aluminum, nickel, titanium, copper, or silver. The thickness of the electrode layers E1 and E2 is between 0.1 um to 1.5 um. The material of the dielectric layer DE1 may include silicon dioxide, aluminum oxide, or silicon nitride. The thickness of the dielectric layer DE1 is between 0.1 um to 1.5 um. The gap between the dielectric layer DE1 and the electrode layer E2 is between 0.03 um and 0.5 um. The electrode layer E1 is coupled to the driving circuit 102, and the electrode layer E2 is coupled to the corresponding sensing circuit SA1. In addition, the selection circuit 110 is coupled to the sensing circuits SA1 to SA3 and the processing circuit 112. In some embodiments, the driving circuit 102 may include a direct-current voltage generating circuit Vdc and a waveform generating circuit Vac as shown in FIG. 2. The direct-current voltage generating circuit Vdc is coupled to the capacitive micromachined ultrasonic transducer array and the waveform generating circuit Vac.

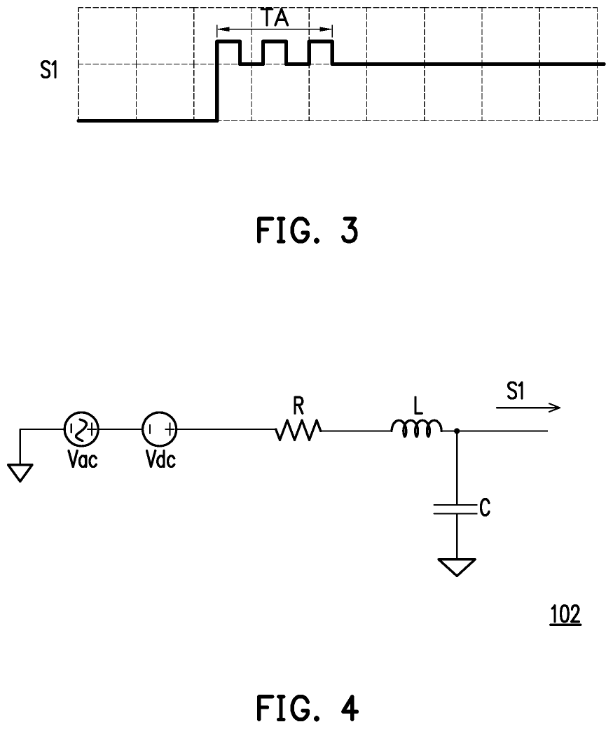

During a transmission period, the driving circuit 102 may output a driving signal S1, and drives the capacitive micromachined ultrasonic transducer array to transmit a planar ultrasonic wave to a finger to generate a plurality of reflected ultrasonic signals. During a receiving period, each capacitive micromachined ultrasonic transducer may receive the reflected ultrasonic signals to generate a plurality of sensing current signals IS1 to ISN. To be more specific, during the transmission period, the waveform generating circuit Vac may provide an alternating-current voltage with a predetermined waveform, and the direct-current voltage generating circuit Vdc may provide a direct-current voltage. Taking the driving signal S1 shown in FIG. 3 as an example, during a transmission period TA, the waveform generating circuit Vac may provide a square wave signal to be combined with the direct-current voltage provided by the direct-current voltage generating circuit Vdc to generate the driving signal S1 as shown in FIG. 3. After the electrode layer E1 of each capacitive micromachined ultrasonic transducer receives the driving signal S1, an electric field between the electrode layer E1 and the electrode layer E2 is varied because of the driving signal S1. As such, the electrode layer E1 and the electrode layer E2 vibrate in response to the driving signal S1 to generate an ultrasonic signal. Then, the capacitive micromachined ultrasonic transducer array emits the planar ultrasonic wave to a finger of a user, and the reflected ultrasonic signals are generated after the planar ultrasonic wave is reflected by the finger.

After the transmission period TA ends, the waveform generating circuit Vac may stop providing the alternating-current voltage, and accordingly the capacitive micromachined ultrasonic transducer array stops emitting the planar ultrasonic wave, while the direct-current voltage generating circuit Vdc continues to provide the direct-current voltage. During the receiving period, the electric field between the electrode layers E1 and E2 of the capacitive micromachined ultrasonic transducers CM1 to CM3 is varied as the reflected ultrasonic signal is received. Thereby, the corresponding sensing current signals IS1 to ISN are generated.

The sensing circuits SA1 to SAN may respectively receive the sensing current signals IS1 to ISN, and generate a plurality of fingerprint sensing signals FS1 to FSN according to the sensing current signals IS1 to ISN. The fingerprint sensing signals FS1 to FSN are respectively proportional to the sensing current signals IS1 to ISN. The selection circuit 110 may selectively output the fingerprint sensing signals FS1 to FSN to the processing circuit 112 according to a column and row selection signal, such that the processing circuit 112 generates a fingerprint image according to the fingerprint sensing signals FS1 to FSN, and performs fingerprint recognition processing on the fingerprint image.

As such, in fingerprint sensing through the capacitive micromachined ultrasonic transducers, the required AC drive voltage is reduced. In addition, the signal emission receiving layer 104 including the capacitive micromachined ultrasonic transducers may be formed on the glass substrate with the sensing circuit layer 106 in the same TFT process, instead of being manufactured in different processes and then joined together. Compared with manufacturing utilizing a silicon substrate, the costs are reduced, facilitating application to large-area fingerprint sensing.

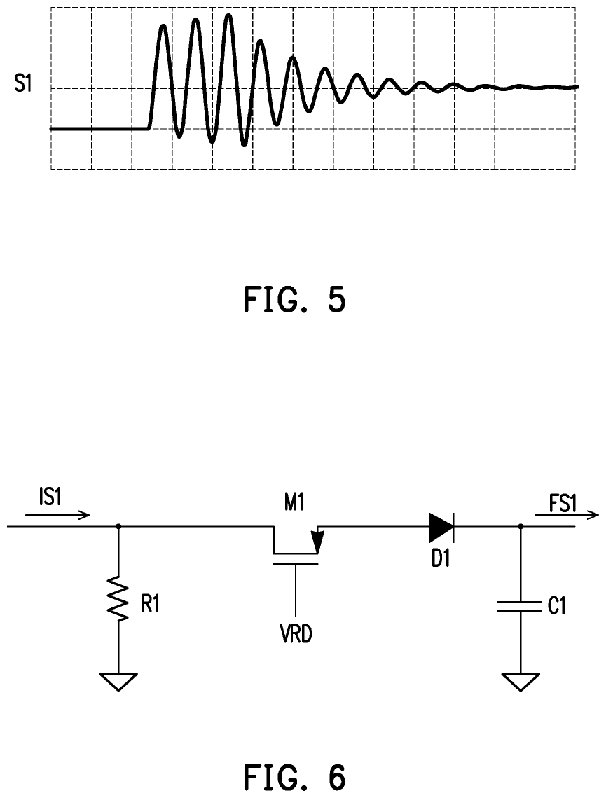

Notably, in some embodiments, the waveform generated by the driving circuit 102 is not limited to a square wave. For example, FIG. 4 is a schematic diagram of a driving circuit according to an embodiment of the disclosure. Compared with the embodiment of FIG. 2, the driving circuit 102 of this embodiment also includes a resistor R, an inductor L, and a capacitor C in addition to the waveform generating circuit Vac and the direct-current voltage generating circuit Vdc. The resistor R is coupled to one terminal of the direct-current voltage generating circuit Vdc and one terminal of the inductor L, and another terminal of the inductor L is coupled to an output terminal of the driving circuit 102. The capacitor C is coupled between the output terminal of the driving circuit 102 and a reference voltage (the reference voltage in this embodiment is a ground, but not limited thereto). Through the resistor R, the inductor L, and the capacitor C, the driving circuit 102 may generate the driving signal Si similar to a tone burst signal shown in FIG. 5.

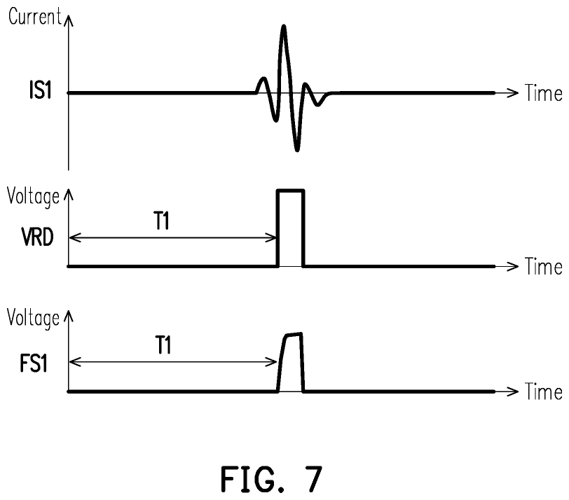

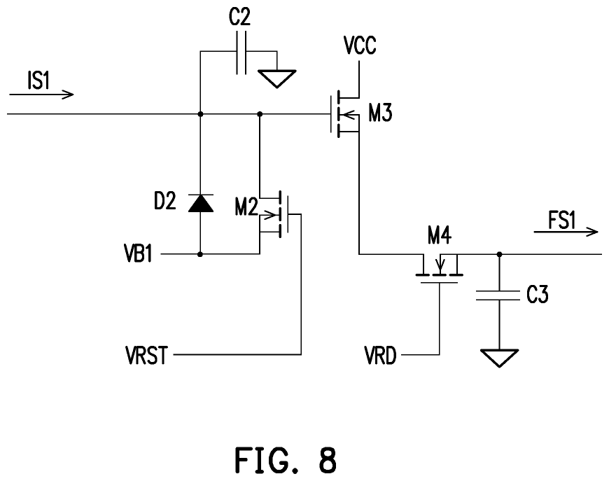

FIG. 6 is a schematic diagram of a sensing circuit according to an embodiment of the disclosure. Specifically, each sensing circuit may be implemented as shown in FIG. 6, including a resistor R1, a reading transistor M1, a rectifier diode D1, and a capacitor C1. Taking the sensing circuit SA1 as an example, the resistor R1 is coupled between a first terminal of the reading transistor and a ground, the first terminal of the reading transistor M1 is coupled to an output terminal of the corresponding capacitive micromachined ultrasonic transducer CM1. An anode terminal and a cathode terminal of the rectifier diode D1 are coupled between a second terminal of the reading transistor M1 and an output terminal of the sensing circuit SA1. The capacitor C1 is coupled between the cathode terminal of the rectifier diode D1 and the ground. A control terminal of the reading transistor M1 may receive a reading control signal VRD during a receiving period, the reading transistor M1 is controlled by the reading control signal and enters a turn-on state during a reading period, and the receiving period includes the reading period. To be more specific, after the capacitive micromachined ultrasonic transducer array emits a planar ultrasonic wave during a transmission period, since a period of time is required before the planar ultrasonic wave is transformed into a reflected ultrasonic signal to return to the capacitive micromachined ultrasonic transducer array, each sensing circuit may be enabled after a predetermined period of time after the capacitive micromachined ultrasonic transducer array emits the planar ultrasonic wave during the transmission period. As shown in FIG. 7, the reading control signal VRD may be converted to a high voltage level after a predetermined period of time T1 after the capacitive micromachined ultrasonic transducer array emits the planar ultrasonic wave during the transmission period, such that the reading transistor M1 enters the turn-on state to sample the sensing current signal IS1. The sensing current signal IS1 may be converted into the fingerprint sensing signal FS1 through the rectifier diode D1 and the capacitor C1 to be output by the sensing circuit SA1. Notably, in some embodiments, the reading transistor M1 may enter the reading period multiple times during the receiving period to sample out a plurality of fingerprint sensing signals at different time points for the processing circuit 112 to generate fingerprint images accordingly.

FIG. 8 is a schematic diagram of a sensing circuit according to another embodiment of the disclosure. In this embodiment, each sensing circuit may, for example, be implemented as shown in FIG. 8, including a reset transistor M2, a conversion transistor M3, a reading transistor M4, a rectifier diode D2, and capacitors C2 and C3. Take the sensing circuit SA1 as an example, a first terminal of the reset transistor M2 is coupled to a reset voltage VB1, a second terminal of the reset transistor M2 is coupled to the corresponding capacitive micromachined ultrasonic transducer CM1, and a control terminal of the reset transistor M2 is coupled to a reset control signal. An anode terminal and a cathode terminal of the rectifier diode D2 are respectively coupled to a first terminal and a second terminal of the reset transistor. The capacitor C2 is coupled between the cathode terminal of the rectifier diode D2 and a ground. A control terminal of the conversion transistor M3 is coupled to the cathode terminal of the rectifier diode D2, and a first terminal of the conversion transistor M3 is coupled to a power supply voltage VCC. A first terminal of the reading transistor M4 is coupled to a second terminal of the conversion transistor M3, a second terminal of the reading transistor M4 is coupled to the output terminal of the sensing circuit SA1, and a control terminal of the reading transistor M4 receives the reading control signal VRD. In addition, the capacitor C3 is coupled between the second terminal of the reading transistor and the ground.

During a reset period, the reset transistor M2 may be controlled by a reset control signal VRST and enter a turn-on state during the reset period, such that the reset voltage VB1 resets the voltage at the control terminal of the conversion transistor M3. During a receiving period, the conversion transistor M3 may generate the corresponding fingerprint sensing signal FS1 at the second terminal of the conversion transistor M3 in response to the sensing current signal IS1 provided by the capacitive micromachined ultrasonic transducer CM1. The reading transistor M4 may be controlled by the reading control signal VRD and enter a turn-on state during a reading period to transmit the fingerprint sensing signal FS1 through the selection circuit 110 to the processing circuit 112 for fingerprint recognition processing.

Notably, a capacitive micromachined ultrasonic transducer array is taken as an example for description in the above embodiments, but the disclosure is not limited thereto. In other embodiments, the capacitive micromachined ultrasonic transducer array may also be replaced by a piezoelectric micromachined ultrasonic transducer array formed by a plurality of piezoelectric micromachined ultrasonic transducers or a piezoelectric thin-film micromachined ultrasonic transducer array formed by a plurality of piezoelectric thin-film micromachined ultrasonic transducers for implementation.

In summary of the foregoing, in the embodiments of the disclosure, the driving circuit may drive the micro-machined ultrasonic transducer array to emit the planar ultrasonic wave to the finger during the transmission period to generate the reflected ultrasonic signals. The micromachined ultrasonic transducer may receive the reflected ultrasonic signals during the receiving period to generate the sensing current signals. The sensing circuit senses the sensing current signals output by the micromechanical ultrasonic transducers to generate the fingerprint sensing signals. Compared with fingerprint sensing utilizing piezoelectric micromachined ultrasonic transducers, fingerprint sensing utilizing the micromachined ultrasonic transducers requires a lower AC drive voltage. In addition, since the micromachined ultrasonic transducers may be formed on a glass substrate, compared to the manufacturing using a silicon substrate, the manufacturing costs are reduced, facilitating application to large-area fingerprint sensing.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A fingerprint sensing apparatus, comprising:
a signal emission receiving layer, comprising a capacitive micromachined ultrasonic transducer array formed by a plurality of capacitive micromachined ultrasonic transducers;
a driving circuit coupled to the capacitive micromachined ultrasonic transducer array, and driving the capacitive micromachined ultrasonic transducer array to emit a planar ultrasonic wave to a finger during a transmission period to generate a plurality of reflected ultrasonic signals, wherein the capacitive micromachined ultrasonic transducers receive the reflected ultrasonic signals during a receiving period to generate a plurality of sensing current signals;
a sensing circuit layer comprising a plurality of sensing circuits, wherein the sensing circuits are respectively coupled to the corresponding capacitive micromachined ultrasonic transducers, and sense the sensing current signals output by the capacitive micromachined ultrasonic transducers to generate a plurality of fingerprint sensing signals; and
a substrate, wherein the sensing circuit layer is formed on the substrate, and the signal emission receiving layer is formed on the sensing circuit layer, and wherein the substrate is a glass substrate or a silicon substrate.

2. The fingerprint sensing apparatus according to claim 1, wherein the sensing circuit layer further comprises:
a selection circuit coupled to the sensing circuits, and selectively outputting the fingerprint sensing signals according to a column and row selection signal.

3. The fingerprint sensing apparatus according to claim 1, wherein the fingerprint sensing signals are respectively proportional to the sensing current signals.

4. The fingerprint sensing apparatus according to claim 2, further comprising:
a processing circuit coupled to the selection circuit, generating a fingerprint image according to the fingerprint sensing signals, and performs fingerprint recognition processing on the fingerprint image.

5. The fingerprint sensing apparatus according to claim 1, wherein each of the capacitive micromachined ultrasonic transducers comprises:
a first electrode layer coupled to the driving circuit;
a dielectric layer; and
a second electrode layer coupled to the corresponding sensing circuit, wherein the dielectric layer is disposed between the first electrode layer and the second electrode layer, a cavity is present between the first electrode layer and the second electrode layer, the driving circuit provides a driving signal to the first electrode layer, such that the first electrode layer and the second electrode vibrate in response to the driving signal to emit an ultrasonic signal, and the second electrode layer generates the sensing current signal in response to a capacitance value change between the first electrode layer and the second electrode layer during the receiving period.

6. The fingerprint sensing apparatus according to claim 5, wherein a capacitive gap between the dielectric layer and the second electrode layer is between 0.03 μm and 0.5 μm.

7. The fingerprint sensing apparatus according to claim 1, wherein the driving circuit comprises:
a direct-current voltage generating circuit providing a direct-current voltage; and
a waveform generating circuit connected in series with the direct-current voltage generating circuit between the capacitive micromachined ultrasonic transducers and a reference voltage, and providing an alternating-current voltage with a predetermined waveform during the transmission period.

8. The fingerprint sensing apparatus according to claim 7, wherein the driving circuit further comprises:
a resistor having a first terminal coupled to the waveform generating circuit;
an inductor having a first terminal coupled to a second terminal of the resistor, and a second terminal coupled to the capacitive micromachined ultrasonic transducers; and
a capacitor coupled between the second terminal of the inductor and the reference voltage.

9. The fingerprint sensing apparatus according to claim 8, wherein each of the sensing circuits is enabled after a predetermined period of time after the capacitive micromachined ultrasonic transducer array emits the planar ultrasonic wave.

10. The fingerprint sensing apparatus according to claim 7, wherein the predetermined waveform is a square wave.

11. The fingerprint sensing apparatus according to claim 1, wherein each of the sensing circuits comprises:
a reading transistor having a first terminal coupled to an output terminal of the corresponding capacitive micromachined ultrasonic transducer, and a control terminal receiving a reading control signal, wherein the reading transistor is controlled by the reading control signal and enters a turn-on state during a reading period;
a resistor coupled between the first terminal of the reading transistor and a reference voltage;
a rectifier diode having an anode terminal and a cathode terminal coupled between a second terminal of the reading transistor and an output terminal of the corresponding sensing circuit; and
a capacitor coupled between the cathode terminal of the rectifier diode and the reference voltage.

12. The fingerprint sensing apparatus according to claim 11, wherein each of the sensing circuits is enabled after a predetermined period of time after the capacitive micromachined ultrasonic transducer array emits the planar ultrasonic wave.

13. The fingerprint sensing apparatus according to claim 1, wherein each of the sensing circuits comprises:
a reset transistor having a first terminal coupled to a reset voltage, a second terminal coupled to the corresponding capacitive micromachined ultrasonic transducer, and a control terminal coupled to a reset control signal, wherein the reset transistor is controlled by the reset control signal and enters a turn-on state in a reset period;
a rectifier diode having an anode terminal and a cathode terminal respectively coupled to the first terminal and the second terminal of the reset transistor;
a first capacitor coupled between the cathode terminal of the rectifier diode and a reference voltage;
a conversion transistor having a control terminal coupled to the cathode terminal of the rectifier diode, and a first terminal coupled to a power supply voltage, wherein in response to the sensing current signal provided by the corresponding capacitive micromachined ultrasonic transducer, the conversion transistor generates the corresponding fingerprint sensing signal at a second terminal of the conversion transistor;
a reading transistor having a first terminal coupled to the second terminal of the conversion transistor, a second terminal coupled to an output terminal of the corresponding sensing circuit, and a control terminal receiving a reading control signal, wherein the reading transistor is controlled by the reading control signal and enters a turn-on state during a reading period; and
a second capacitor coupled between the second terminal of the reading transistor and the reference voltage.

14. The fingerprint sensing apparatus according to claim 13, wherein each of the sensing circuits is enabled after a predetermined period of time after the capacitive micromachined ultrasonic transducer array emits the planar ultrasonic wave.

15. The fingerprint sensing apparatus according to claim 11, wherein the receiving period comprises the reading period.

16. The fingerprint sensing apparatus according to claim 13, wherein the receiving period comprises the reading period.
